(19) United States
(12) Patent Application Publication
(10) Pub. No.: US 2026/0273396 A1
(43) Pub. Date: Sep. 17, 2026

(54) AI-ASSISTED ASSET SEPARATION, EDITING, AND REINTEGRATION

(71) Applicants: Sony Interactive Entertainment Inc., Tokyo (JP); Sony Interactive Entertainment LLC, San Mateo, CA (US)

(72) Inventors: Jeffrey R. Stafford, Redwood City, CA (US); Joseph Logan Olson, Glendale, CA (US); Nathan Gross, Aliso Viejo, CA (US); Bandaly Azzam, Anaheim Hills, CA (US)

(73) Assignees: Sony Interactive Entertainment Inc., Tokyo (JP); Sony Interactive Entertainment LLC, San Mateo, CA (US)

(21) Appl. No.: 19/078,908

(22) Filed: Mar. 13, 2025

(51) Int. Cl. A63F 13/355; A63F 13/358; A63F 13/52; A63F 13/67; G06F 40/30

(52) U.S. Cl. CPC A63F 13/355; A63F 13/358; A63F 13/52; A63F 13/67; G06F 40/30

(57) ABSTRACT

A method performed by a cloud server system includes selecting, responsive to a request from a client device, an asset of a video game application, the asset comprising a visual element rendered in a first virtual environment of the video game application. The method also includes extracting from the asset, sub-asset data associated with one or more characteristics of the visual element. The method also includes transmitting the sub-asset data to the client device for local editing performed using a game editing application on the client device to thereby generate a modified sub-asset. The method also includes reintegrating the modified sub-asset into the asset of the video game application.

### BACKGROUND

Modern game consoles, such as the PlayStation® 5 video game console, are sophisticated machines capable of providing engaging video game and entertainment experiences. A game console helps to streamline the gaming industry by providing a common platform of standardized resources (e.g., hardware and software) for the development, distribution, and execution of video games. In this manner, game developers can optimize their game development for the game console and provide consumers with a seamless video game experience devoid of concerns about video game compatibility, optimization, or complicated setup with respect to the platform on which the game is run.

A fairly recent development enabled by the proliferation of the Internet is the rise of cloud gaming, in which a video game is executed remotely (e.g., in a remote data center), with gameplay being streamed over the Internet to a user's local client device. More specifically, gaming inputs are transmitted from the client device over the Internet to the cloud executed video game, and the gameplay video generated by the video game is streamed over the Internet to the client device for rendering on a display. However, while such advantages of the game console ecosystem are afforded for the consumer, because of the proprietary nature of game console hardware, supporting game development can be more complex. The game console must be adapted in various ways to accommodate the needs of game developers, or additional specialized hardware must be created to enable game development. Furthermore, these game development specialized systems are not easily adapted for cloud-based development.

### BRIEF DESCRIPTION OF THE DRAWINGS

The disclosure may be better understood by reference to the following description taken in conjunction with the accompanying drawings in which:

FIG. 1 illustrates an example computing environment for a video game console, according to embodiments of the present disclosure.

FIG. 2 illustrates an example computing environment for cloud game development, according to an embodiment of the present disclosure.

FIG. 3 illustrates an example of the machine learning module of FIG. 2, according to an

[symbol]

FIG. 4 illustrates an example of a process for AI-assisted asset separation, editing, and reintegration, according to an embodiment of the present disclosure

FIG. 5 illustrates an example computing environment for cloud game development, according to an embodiment of the present disclosure.

FIG. 6 illustrates an example of a computer system suitable for implementing techniques of the present disclosure, according to embodiments of the present disclosure.

In the appended figures, similar components and/or features can have the same reference label.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Embodiments of the present disclosure are directed to, among other things, AI-assisted asset separation, editing, and reintegration for large-scale assets in cloud gaming development. For example, during development of a video game a client device may access a portion (e.g., digital content associated with a game level, an in-game region of the video game application, and so on) of a video game application, such as by downloading the portion to the client device. The portion may include one or several assets each comprising asset data and sub-asset data. The asset data may represent visual elements rendered in the video game application and the sub-asset data may comprise one or more characteristics associated with the visual elements. In some examples, the asset may be defined as a multidimensional model (e.g., a three-dimensional (3D) model, a four-dimensional (4D) model, etc.). In some examples, the asset can also be defined using a mesh, primitives, texture, geometries, and so on to define the presentation (e.g., the visual element) thereof. In other examples, the asset can also be defined as a volumetric neural model, such as one represented using Gaussian splatting. In some examples, the asset data or sub-asset data can include metadata associated with the asset such as non-player character (NPC) path data, collision data, audio data, or any other metadata data applicable to the particular video game application. Hereinafter, the term “asset data” or “sub-asset data” can thus refer to any of the foregoing and all types of data created and edited by video game developers (including, but not limited to, graphic artists, game level designers, audio engineers, programmers, game level editors, etc.).

Generally speaking, however the asset is defined, the asset defines the presentation of visual elements rendered in a video game application such as geometry characteristics, textures, materials, graphics, artwork, sounds, animations, shadings, audio or any other individual pieces (or a combination of individual pieces) of the digital content. The combination of assets, including relevant sub-asset data, make up the video game application such that when the video game application is rendered, for example on a client device hosting an instance of the video game application, all assets and sub-asset data are rendered in a virtual environment for viewing and interaction by a user of the client device.

During development of the video game application, a video game developer may be developing some aspects of the video game application, such as specific assets and/or sub-assets within video game application (e.g., “assets and/or sub-asset of interest”). For specific asset and/or sub-asset of interest, many or even most of the remaining assets and/or sub-assets in the video game application that are not of interest may be irrelevant for such development. Thus, to reduce latency in transferring video game application data to local client devices for local asset and/or sub-asset editing, and to more efficiently consume computing resources, a cloud server system hosting the video game application can be configured to implement AI assisted techniques to selective extract assets and/or sub-assets of interest from a video game application, transmit data associated with the extracted assets and/or sub-assets of interest to a client device for local editing, and reintegrated the modified asset or sub-asset data into the video game application.

In a particular example, a video game application may include a game level taking place on a floor of a museum. The virtual environment rendered by a gaming engine hosting the video game application may include artwork assets such as paintings, sculptures, etc., furniture assets, such as cabinets, couches, lighting, etc., building assets, such as flooring, windows, walls, etc., gaming assets, such as a weaponry, maps, player character accessories, and so on. Each asset can also include additional sub-asset data associated with one or more characteristics of the asset such as 3D modeling data, geometry characteristics, textures, materials, graphics, artwork, sounds, animations, shadings, and so on. The combination of assets of the video game application may be realistically rendered with a relatively high level of detail, and thus digital files for the assets and sub-asset data may be relatively large.

A video game developer seeking to edit the virtual environment of the video game application may use a client device to develop new assets, modify existing assets, test various effects of assets for a player character on the floor of the game level, and so on. The client device may be remotely located from a cloud server system that hosts the video game application. Such development of a particular asset, such as the sub-asset texture data associated with the cabinets in the game level, may not involve any modifications or even any interactions with the artwork assets or gaming assets. But, because the artwork assets and gaming assets may be large in size, such as up to multiple terabytes each, it may take significant amounts of time (e.g., up to hours) for the entire floor of the museum to be downloaded from the cloud server system and rendered on the client device for local edits to the sub-asset texture data associated with the cabinets. Then, the client device may continue to render large-scale assets, such as the artwork assets, while developing other portions of the gaming application, further consuming unnecessary computing resources.

Rather than transferring irrelevant large-scale assets as-is and in their entirety to the client device, the cloud server system can instead selectively extract asset or sub-asset data of interest from such large-scale assets responsive to a request received from the client device. More specifically, the video game developer can transmit a request from a game editing application hosted by the client device. In some examples, the request can include a text prompt specifying an asset and/or sub-asset of interest. The cloud server system can receive and interpret request.

Using a machine learning module, the cloud server system can interpret the request and selectively extract the asset and sub-asset data of interest. More specifically, and according to one implementation, a game engine of the cloud server system can render a virtual environment of the video game application and capture, using a virtual camera, a set of two-dimensional (2D) images of the virtual environment at different angles at which a player character may view the virtual environment. A feature representation module of the machine learning module, which can include a pair of neural networks where a first neural network is configured for image understanding and a second neural network is configured for text understanding, can encode text data from a request received from the client device and the images captured using the virtual camera into feature representations. Then, a large multimodal model (LMM) can perform latent space processing on the feature representations by comparing feature vectors of the set of 2D images to a feature vector representing a semantic content of the request. Based on a text-image pair identified in a shared vector space the large multimodal model can selectively extract the asset and/or sub-asset data of interest. In some examples, the machine learning module 250 may be implemented as a vision language model (VLM) configured to perform the functionality described with respect to the feature representation module and the large multimodal model performing latent space processing.

Once extracted, the asset and/or sub-asset data of interest, having smaller data size as compared to the data size of the video game application, may be transmitted to the client device of the video game developer for local downloading. The video game developer may perform edits and modifications to the asset and sub-asset data of interest. In some examples, such edits and modifications may be performed at the client device via language model prompting, such as by prompting a large language model (LLM) to perform edits and modifications to the asset data and/or the sub-asset data.

After the video game developer has completed editing, the modified sub-asset and/or modified asset may be reintegrated into the video game application. More specifically, the modified sub-asset or modified asset may be received back by the cloud server system and reintegrated into the video game application using the above-mentioned machine learning module. More specifically, the machine learning module may be further configured to include a reintegration module comprising, for example, one or more additional machine learning models (e.g., encoder-decoder pairs and latent space processing functionality) trained to connect modified asset data or the modified sub-asset data with the original asset data or original sub-asset data of the video game application (e.g., replace the original data with modified data).

In addition, the machine learning module can be further configured to perform post-processing checks on the video game application incorporating the modified asset data and/or modified sub-asset data. For instance, the game engine of the cloud server system can render a new virtual environment of the video game application and capture, using the virtual camera, a set of 2D images of the new virtual environment including the reintegrated modified asset/sub-asset. The machine learning module can then compare the set of 2D images of the new virtual environment to a set of 2D images of the original virtual environment to determine a variance. Responsive to the variance satisfying a threshold (indicating a change beyond what was intended by the video game developer), an indication of such an error can be transmitted to the client device and the video game developer can perform revisions. In some examples, the machine learning module may automatically perform revisions to the video game application without human interaction.

It will be appreciated that in video game development, often times data associated with assets and/or sub-assets may be reused across the video game application. For example, sub-asset data associated with a texture (e.g., a wooden texture) of a cabinet asset may also be used for a flooring asset to visual illustrate wooden flooring textures. As yet another example, asset data associated with a couch in a particular game level may be used to visually render the same couch in a different game level. As such, there may be instances where a video game developer has modified an asset and/or sub-asset and wishes to propagate such edits to all instances of the asset and/or sub-asset in the video game application. To enable proper reintegration of the modified asset and/or sub-asset, the cloud server system can extract metadata from the asset and/or sub-asset where the metadata provides an indication of instances in the video game application where the asset and/or sub-asset are utilized thereby establishing a set of dependencies. As part of the post-processing check, the machine learning module can traverse the set of dependencies described by the metadata and perform an analysis to ensure that all instances of the asset and/or sub-asset modifications have been properly reintegrated. In some examples where such metadata is not available, the machine learning module can receive 2D images of the rendered video game application and generate metadata based on a visual analysis of the images in order to establish the set of dependencies.

Embodiments of the present disclosure can provide several advantages over existing techniques in cloud gaming development. Conventional techniques may involve downloading large-scale assets, which may be time consuming and unnecessary in many development situations. By extracting asset data and/or sub-asset data from the video game application, embodiments described herein can significantly reduce latency involved in transferring portions of the video game application to a remote client device. The remote client device may consume fewer computing resources by downloading and rendering smaller portions of digital content from the video game application. As such, embodiments of the present disclosure improve the functioning of a computer by reducing the overall size of assets and/or sub-asset data to be downloaded and transmitted to a client device for local editing and modification thereby increasing transfer speeds and efficiencies and saving computer resources, such as improving and/or freeing up additional memory space. For instance, a reduction in asset and/or sub-asset data size can save memory space to enable computer resources are available for running other applications and processes more efficiently. When memory is conserved, the local client device can handle multitasking operations more efficiently reducing the likelihood of slowdowns or crashes thereby optimizing overall performance.

In the interest of clarity of explanation, the embodiments can be described in connection with development of a video game application usable by a video game console, such as a virtual gaming consol hosted by a cloud server system. However, the embodiments are not limited as such and can similarly apply to any other type of a computer system.

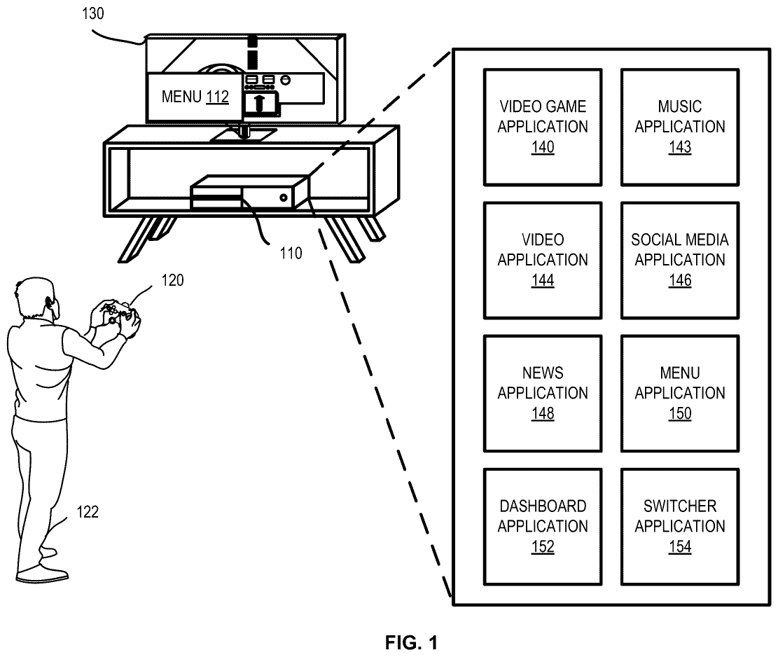

FIG. 1 illustrates a computer system, according to an embodiment of the present disclosure. As illustrated, the computer system includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A user 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login). In addition, the video game console 110 includes a menu application 150, a dashboard application 152, and a switcher application 154. The menu application 150 can present a home user interface (UI) in a GUI of the display 130. The dashboard application 152 can present an arrangement of interactive UI widgets in a dashboard page on the GUI. And the switcher application 154 can present a ribbon of UI elements in a ribbon menu on the GUI to allow scrolling between different UI elements and switching between corresponding applications.

Development of the one or more applications (e.g., video game applications 140, music application 143, video application 144, etc.) on video game console 110 can be performed by a developer (e.g., a video game developer). Such developments may include initial building the applications as well as performing updates, edits, and/or modifications to the application after release. Such updates, edits, and/or modifications may be performed via a client device used by the video game developer and provided to video game console 110 over a network, such as the Internet.

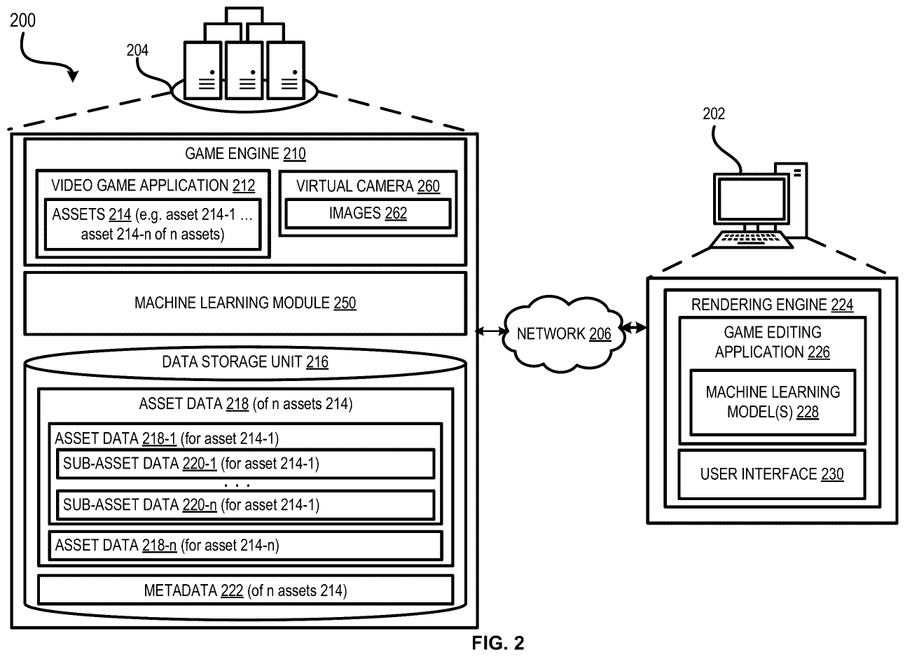

FIG. 2 illustrates an example computing environment 200 for cloud game development, according to an embodiment of the present disclosure. The computing environment 200 can include a client device 202 and a cloud server system 204 communicatively coupled via a wireless network 206 (e.g., the Internet). The cloud server system 204 can host a video game application 212 via a game engine 210. An example of the game engine 210 can be Unreal® Engine.

Game engine 210 includes video game application 212. The video game application 212 can comprise a set of n assets 214. Assets 214 can be digital content (e.g., data objects) that make up the video game application 212, such as representations of characters, buildings, vehicles, textures, sounds, animations, props, or any other elements (e.g., individual elements or a combination of elements) of the video game application 212. In some examples, assets 214 can be defined as a multidimensional model (e.g., 3D model, a 4D model, etc.). The asset can be defined using a mesh, primitives, texture, and so on to define the presentation (e.g., rendering) thereof. In some examples, assets 214 can also be defined as a volumetric neural model, such as one represented using Gaussian splatting. Each of the assets 214 (e.g., asset 214-1, . . . 214-n) can comprise data associated with the video game application 212 and usable by game engine 210 to render the video game application 212. The visual presentation of assets 214 may have dimension (e.g., may be 2D or 3D) and may have various attributes, including visual properties such as geometric characteristics, textures, materials, graphics, artwork, sounds, animations, shadings, and so on. Some assets 214 may be relatively large in order to be rendered with high fidelity. For instance, some assets 214 may have data sizes of terabytes or more. Generally speaking, when assets 214 are rendered in the video game application 212 via game engine 210, assets 214 visually depict digital content associated with the video game application 212 such as artwork assets like paintings, sculptures, etc., furniture assets like cabinets, couches, lighting, etc., building assets like flooring, windows, walls, etc., gaming assets like a weaponry, maps, player character accessories, and so on.

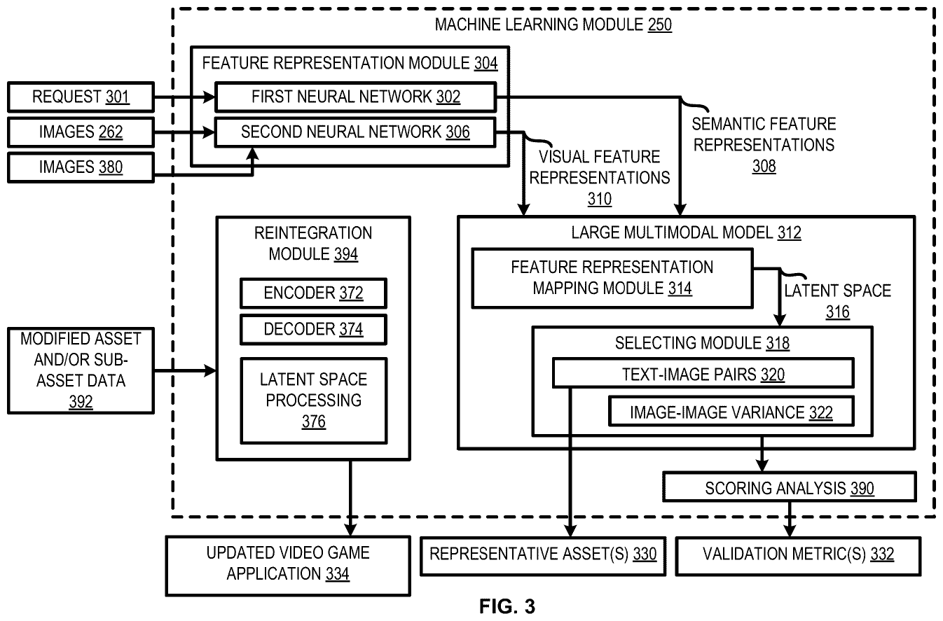

Game engine 210 also includes virtual camera 260 for capturing a plurality of images 262. Images 262 may be 2D images of the virtual environment rendered by game engine 210 executing video game application 212. Images 262 may be utilized by machine learning module 250 of cloud server system 204 to selectively extract assets 214 of interest as well as assist with reintegration of the modified assets, as described in more detail with respect to FIG. 3.

Cloud server system 204 also includes data storage unit 216. Data storage unit 216 can store data associated with assets 214 (e.g., data for each of asset 214-1 . . . 214-n). The data storage unit 216 may comprise a local or remote storage device or other memory suitable for storing information accessible to game engine 210. For instance, data storage unit 216 includes asset data 218 of n assets 214. Asset data 218-1 can be associated with asset 214-1 and can include sub-asset data 220-1 . . . 220-n. As previously mentioned, assets 214 may comprise visual elements rendered in the video game application 212. The sub-asset data for each asset may comprise one or more characteristics associated with the visual elements of the asset. For instance, sub-asset data 220-1 . . . 220-n can include, but is not limited to, data for defining three-dimensional model(s) of asset 214-1, geometric characteristic(s) of asset 214-1, texture(s) of asset 214-1, material(s) of asset 214-1, graphic(s) of asset 214-1, artwork of asset 214-1, sound(s) implemented by of asset 214-1, animation(s) associated with asset 214-1, shading(s) and coloring(s) of asset 214-1, or any other individual pieces (or a combination of individual pieces) of digital content usable to render asset 214-1 in video game application 212. The combination of asset data 218, including respective sub-asset data, are executed by the video game application 212 such that when the video game application 212 is rendered by game engine 210, a virtual environment including all relevant assets 214 are displayed for viewing and interaction.

Data storage unit 216 also includes metadata 222. Metadata 222 can comprise data that describes asset data 218. For instance, metadata 222 can include metadata for n assets 214, including respective sub-asset data. As such, asset data 218-1 may comprises metadata 222, sub-asset data 220-1 may comprise metadata 222, and so on. In one implementation, metadata 222 provides a description/indication of instances in the video game application 212 where the assets 214, including respective sub-asset data, are utilized thereby establishing a set of dependencies. Often times asset data 218 including respective sub-asset data may be reused (e.g., comprise multiple instances) across the video game application 212 during runtime. For example, assume asset 214-1 describes a chair asset, asset data 218-1 comprises data associated with rendering the chair in a virtual environment of the video game application 212, and sub-asset data 220-1 comprises data associated with a texture (e.g., a wooden texture) of the chair asset. Metadata 222 can be included in asset data 218-1 describing all instances in the video game application 212 where the chair asset is utilized (e.g., at various game levels, in various different scenes of the virtual environment, etc.). Moreover, metadata 222 can be included in sub-asset data 220-1 describing all instances in the video game application 212 where the data associated with the wooden texture is utilized in the video game application 212 (e.g., the chair asset rendered in different levels, or the wooden texture implemented in other assets, such as flooring). As such, metadata 222 can provide a set of dependencies linking assets 214 and sub-asset data to all instances of occurrence in the video game application 212 during runtime. During game editing by client device 202, in cases where a video game developer has modified an asset and/or sub-asset and wishes to propagate such edits to all instances of the asset and/or sub-asset in the video game application, cloud server system 204 may traverse all dependencies described by metadata 222 to propagate the edits appropriately, as described in more detail below.

The video game application 212 may be in development. In cloud gaming development, it may be common for video game developers to be distributed around the world. Thus, accessing some or all portions of the video game application 212 to develop the video game application 212 may involve downloading large-scale assets 214 over significant distances, such as over thousands of miles. In many cases, a developer may work on a portion of the video game application 212 that includes large-scale assets 214 that may not be modified during a development session. For example, the video game application 212 may be a racecar video game. The developer may wish to test different models of cars on a racetrack in the video game application 212. The racecar setting may include assets 214 such as trees, plants, signage, and the like that may be large-scale assets that are rendered with polygons or voxels. Such assets 214 may not, in some examples, be interactable. For instance, a tree asset may be positioned within a region of the racetrack that is inaccessible to a car driving on the racetrack. Therefore, testing different models of cars on the racetrack may have little to no effect on the visual rendering of the tree assets. It may be a waste of computing resources for the client device 202 to download and fully render such large-scale assets 214 in testing models of cars.

During game development of video game application 212, client device 202 may be used to access portions of the video game application 212, such as by modifying or adding code to the video game application 212. Client device 202 can include a rendering engine 224, a game editing application 226, including one or more machine learning model(s) 228, and a user interface 230. To modify or add code to the video game application 212, the client device 202 may download a copy of some or all of the video game application 212 from the cloud server system 204 via the network 206. The client device 202 may modify, using the game editing application 226, the video game application 212. The client device 202 may view a sample of the modifications and/or additional code as rendered by a local rendering engine on the client device 202 such as rendering engine 224. The client device 202 can then upload modified features of the video game application 212, such as modified features of one or more assets, back to the cloud server system 204.

The user interface 230 of client device 202 enables a user to interact with the client device 202. The user interface 230 may be a touch screen interface, a voice-based interface, or any other interface that allows users to provide input and receive output from one or more applications on the client device 202. A user of the user client device 202 may interact with the cloud server system 104 and game editing application 226 via the user interface 230. In an example, the user interacts via the user interface 230 with the game editing application 226 to submit a request, via network 206, to modify one or more assets of assets 214 or one or more sub-assets of assets 214 of video game application 212. The request may comprise text data semantically describing the asset of interest. To reduce latency and improve computer efficiencies during development of video game application 212, the cloud server system 204 may download a portion of video game application 212 including the assets specified in the request. In some examples, the request may specify the kind of development that will be performed on client device 202 and whether or not the user of client 202 would like to propagate the edits to the asset and/or sub-asset across all instances of the asset and/or sub-asset in the video game application 212. In some examples, cloud server system 204 may use machine learning module 250 to assist with extraction and reintegration of asset data 218, as described in more detail with respect to FIG. 3.

The cloud server system 204 may transmit the asset data 218 or sub-asset data 220 of interest over network 206 for editing by a game developer on client device 202. In this way, only the asset of interest to client device 202 is downloaded and transmitted over network 206. In terms of data size, a total data size of the video game application 212 can be greater than asset data 218 and/or sub-asset data 220. ). The client device 202 may download the transferred data files that include the asset data 218 significantly faster than if the transferred data files included the entire video game application 212. The client device 202 may execute a rendering engine 224 to render the transferred and downloaded data files into a presentation of the video game application 212 that includes the asset data 218.

The developer can then modify or otherwise develop the portion of the video game application 212, without any loss of visual integrity. Upon completion, the developer may upload or otherwise transmit the modified asset, via network 206, back to cloud server system 204. Cloud server system 204, utilizing the machine learning module 250, may reintegrate the modified asset into video game application 212. For instance, machine learning module 250 can comprise one or more machine learning models trained to connect (e.g., replace) the asset data 218 from the original asset 214 in the video game application 212 with the modified asset data received after edits have been performed at client device 202. In addition, machine learning module 250 can perform various post-processing validity checks, as described in more detail with respect to FIG. 3, to ensure the video game application 212, including the modified assets, is rendered properly.

FIG. 3 illustrates an example of the machine learning module 250 of FIG. 2, according to an embodiment of the present disclosure. As mentioned with respect to FIG. 2, machine learning module 250 may be utilized by cloud server system 204 to perform various aspects of asset selection and reintegration according to one or more aspects of the present disclosure. Machine learning module 250 includes a feature representation module 304, LMM 312, having feature representation mapping module 314 and selecting module 318, and reintegration module 394 configured to generate an updated video game application 334 incorporating modified asset and/or sub-asset data 392 and further configured to generate representation asset(s) 330 and/or validation metric(s) 332 based on request 301, images 262, and images 380. In some examples, the machine learning module 250 may be implemented as a VLM configured to perform the functionality with respect to the feature representation module 304, the large multimodal model 312 performing latent space processing, and the reintegration module 394.

As mentioned with respect to FIG. 2, a video game developer may modify or otherwise develop the portion of the video game application 212, without any loss of visual integrity. Upon completion, the developer may upload or otherwise transmit the modified asset, via network 206, back to cloud server system 204. The modified asset may be received by the cloud server system 204 as modified asset and/or sub-asset data 392. Similar to assets 214, in some examples modified asset and/or sub-asset data 392 can be defined as a multidimensional model using a mesh, primitives, texture, and so on to define the presentation (e.g., rendering) thereof, and in some examples, modified asset and/or sub-asset data 392 can also be defined as a volumetric neural model, such as one represented using Gaussian splatting. Modified asset and/or sub-asset data 392 may be provided to reintegration module 394 where reintegration module 394 comprises one or more machine learning models trained to connect (e.g., replace) original asset data or original sub-asset data of the video game application 212 (e.g., data associated with original asset data 218 and/or sub-asset data 220) with modified asset and/or sub-asset data 392. For instance, in the case where modified asset and/or sub-asset data 392 is represented as a multidimensional model, the reintegration module 394 can be trained to connect the mesh of the multidimensional model into the mesh of the asset 214 of the video game application 212.

In one implementation, such as the implementation shown in FIG. 3, reintegration module 394 can include encoder 372, decoder 374, and latent space processing 376 configured to perform the reintegration tasks. More specifically, modified asset and/or sub-asset data 392 is received by encoder 372 of reintegration module 394 as input. Encoder 372 takes the input data and converts the input data into latent space data by extracting features from the input data. Latent space processing 376 performs processing on the latent space data in which similar data points are closer together in space. In the latent space, the processing is configured to learn relationships between learned data points that a machine learning system, such as machine learning module 250, has been able to derive from the information that it is trained on. In the context of reintegration, latent space processing 376 outputs a prediction as to how the modified asset and/or sub-asset data 392 should be incorporated into the original video game application 212. Decoder 374 then transforms the resulting prediction back into a human readable data space. After reintegration of the modified asset and/or sub-asset data 392, machine learning module 250 outputs updated video game application 334 including the modified asset and/or sub-asset data 392.

In another implementation, machine learning module 250 may be configured with additional features and functionality beyond reintegration of modified asset and/or sub-asset data 392. In more detail, machine learning module 250 may be configured to output representative asset(s) 330 based on request 301 and images 262. As mentioned with respect to FIG. 2, a video game developer may want to perform modifications to a particular asset or group of assets (e.g., assets 214) of a video game application, such as video game application 212. In order to reduce latency and download time, the video game developer may only want to receive asset data (e.g., asset data 218) associated with the particular asset of interest. Accordingly, the video game developer may transmit, via network 206, a request 301 to cloud server system 204 specifying the asset(s) 214 of interest. The request 301 may comprise text data. In some examples, the request 301 may also specify the type of development that will be performed on client device 202 and whether or not the user of client 202 would like to propagate the modified asset and/or sub-asset data 392 to all instances of the asset and/or sub-asset in the video game application 212.

The request 301 may be received by a first neural network 302 of feature representation module 304. First neural network 302, which may be a large language model (LLM), a bidirectional encoder representations from transformers (BERT) based model, or other suitable type of machine learning model, may be trained to transform request 301, including the text data, into a semantic feature representation (e.g., semantic feature representations 308). Semantic feature representations 308 may comprise a numerical representation of the request 301 representing the intent of the video game developer (e.g., an underlying purpose or goal) and be based on keywords, phrases, grammatical structure, etc. of the request 301.

In conjunction with request 301, feature representation module 304 may receive, by a second neural network 306, images 262. Images 262, which may comprise a plurality of 2D images, can be captured by using virtual camera 260 of cloud server system 204. For instance, game engine 210 may render a first virtual environment of the video game application 212. Virtual camera 260 may capture a set of 2D images 262 of the virtual environment at different angles at which a player character may view the virtual environment. The images 262 may illustrate the rendered assets 214 of the video game application 212. Second neural network 306, which may comprise a convolutional neural network (CNN), a vision transformer, or other suitable type of machine learning model, may then transform each image of the images 262 into an embedded format (e.g., visual feature representations 310).

Semantic feature representations 308 (corresponding to an embedded format of request 301) and visual feature representations 310 (corresponding to an embedded format of images 362) are then provided to LMM 312. Feature representation mapping module 314 may receive the semantic feature representations 308 and visual feature representations 310 and map the vector representations to a latent space 316. Similar to latent space processing 376, the latent space 316 may refer to a shared vector space between the multiple modalities (e.g., text and images) in which similar data points are closer together in space. In latent space 316, latent space processing can be performed by selecting module 318, which may be configured to learn relationships between learned data points. More specifically, the latent space 316 may be analyzed by selecting module 318 to identify one or more text-image pairs 320. To do so, the LMM 312 may be pre-trained to map vector representations corresponding to semantically and visually similar text-image pairs in close proximity to each other in the latent space 316. For instance, if a video game developer is interested in a “chair” asset for modification, the request 301 may specify the “chair” as the asset as well as a particular instance in the video game application 212 (e.g., a game level) where the chair is used. The LMM 312 may map the semantic feature representations 308 of the request 301 to latent space 316, which may be positioned close to visual feature representations 310 of the “chair” asset. Based on identification of the text-image pair 320, LMM 312 may extract the asset data 218 associated with the identified asset 214 and provide the representative asset(s) 330 (including the respective asset data) for download by client device 202.

Upon download by the client device 202, and as mentioned with respect to FIG. 2, the video game developer can perform edits to the representative asset(s) 330 using game editing application 226. In some examples, the video game developer can utilize machine learning model(s) 228 to assist with the editing process to thereby generate modified asset and/or sub-asset data 392. In some examples, machine learning model(s) 228 can be an LLM, a VLM, an LMM, and so. The machine learning model(s) 228 may be configured to receive a prompt from the video game developer and perform edits to the representative asset(s) 330 based on the prompt. According to one example where the representative asset(s) 330 is a door, the video game developer may prompt the machine learning model(s) 228 to “change the front door of the red house to have more inset panels, make it green color, with some weathering.” The machine learning model(s) 228 understands the asset based on the prompt and performs the variations to the front door geometry, textures, materials, etc. as directed by the prompt. Further, a gallery of variations of the new front door are rendered on user interface 230 via rendering engine 224 at which point the video game developer select the rendering based on preference which may then be reintegrated back into the main asset/level of the video game application 212. Additionally, or alternatively, the video game developer can provide additional prompting to machine learning model(s) 228 such as “make the green darker, the paint should be gloss, not matte, make the door handle shiny brass,” and so on. As a result, a new gallery of renderings appears and one may be selected based on preference of the video game developer.

Turning back to cloud server system 204, machine learning module 250 may also be configured to output validation metric(s) 332 based on images 262. Validation metric(s) 332 may represent a confirmation that reintegration of the modified asset and/or sub-asset data 392 into the video game application 212 has been properly performed. In some examples, validation metric(s) 332 may represent visual errors arising in video game application 212 that may occur due to the reintegration process. As previously described, machine learning module 250 includes reintegration module 394 comprising one or more machine learning models (e.g., implemented by the encoder-decoder pair 372, 374 and latent space processing 376) trained to connect (e.g., replace) the asset data 218 from the original asset 214 in the video game application 212 with the modified asset and/or sub-asset data 392. The analysis for generating validation metric(s) 332 during the reintegration process is two-fold. First, validation metric(s) 332 may describe whether the modified asset and/or sub-asset data 392 has been properly reintegrated into the specific scene and virtual environment selected by the video game developer. Second, validation metric(s) 332 may also describe whether the modified asset and/or sub-asset data 392 has been properly reintegrated into all instances of the asset 214 based on the set of dependencies described by the metadata 222. In each case, the validation metric(s) 332 analysis proceeds in a similar manner.

Initially, game engine 210 executes the updated video game application 334 (including the modified asset and/or sub-asset data 392) to render a virtual environment. Then, cloud server system 204 captures, via virtual camera 260, images 380 of the virtual environment. Similar to images 262, images 380 comprise a set of 2D images of the virtual environment at different angles at which a player character may view the virtual environment. Each of images 380 may be mapped to a respective image of images 262 using second neural network 306 where mapped images share a same angle/point of view of the virtual environment. Second neural network 306 may transform each of images 262 and images 380 into visual feature representations 310. Then, LMM 312 may be trained to analyze the visual feature representations 310 and identify image-image variance 322. Image-image variance 322 may describe a variance between mapped images from images 262 and images 380 in latent space 316. It will be appreciated that some variance will be expected, especially in images 380 that contain the modified asset and/or sub-asset data 392. As such, image-image variance 322 is then provided to scoring analysis 390.

Scoring analysis 390 may perform a scoring analysis based on the image-image variance 322 using a threshold analysis. The threshold may be adjusted based on whether the images being compared contain the modified asset and/or sub-asset data 392 or not. For example, in a case where images are compared that do not contain the modified asset, the image-image variance 322 may be close to zero and in some examples, should be zero. As a result, the threshold used by scoring analysis 390 should be zero or very close to zero. Any image-image variance 322 that exceeds the threshold as detected by selecting module 318 is surfaced and outputted as an error in validation metric(s) 332. Upon receipt of the validation metric(s) 332 the video game developer can perform revisions. In some examples, the machine learning module 250 can automatically edit the video game application 212 to address the error without requiring input from the video game developer.

As another example, in a case where images are compared that contain the modified asset and/or sub-asset data 392, the threshold may be set and/or adjusted based on the type of edit that was performed. It will be appreciated that certain edits may have a larger impact on the rendering than others. For instance, modifications to a texture of a material, a shading of a material, and the like may be relatively minor as compared to modifications to a shape, position, size, etc. of an asset. As such, depending on the type of modification performed, as specified in the request 301 or automatically determined via semantic analysis using the first neural network 302, the threshold may be set and/or adjusted accordingly. Edits classified as having a larger impact may, for example, have a larger threshold thereby allowing for greater image-image variance 322 as compared to edits classified as having a smaller impact.

As yet another example, as previously discussed, it will be appreciated that in video game development, often times data associated with assets and/or sub-assets may be reused across the video game application 212. For instance, sub-asset data associated with a texture (e.g., a wooden texture) of a cabinet asset may also be used for a flooring asset to visually illustrate wooden flooring textures or asset data associated with a couch in a particular game level may be used to visually render the same couch in a different game level. As such, there may be instances where a video game developer has modified an asset and/or sub-asset and wishes to propagate such edits to all instances of the asset and/or sub-asset in the video game application. In these situations, LMM 312 can also evaluate image-image variance 322 between all instances of the rendered modified asset and/or sub-asset data 392 as compared to the original asset data and/or sub-asset data. To do so, the cloud server system 204, by virtue of extracted metadata 222, can traverse the set of dependencies for the modified asset and/or modified sub-asset and insert labels into the images 380 where a modification has been reintegrated. Then, as previously described, scoring analysis 390 may evaluate, using a threshold set based on a classification type of the modification, an image-image variance 322 between the images 380 mapped to images 262 to predict potential errors. As one example, if a car asset is modified to have a different color (e.g., red to black), then LMM 312 can verify that all instances of the specific car asset have been modified in the video game application 212 via a visual comparison. Similarly, LMM 312 can also verify that all instances of a separate vehicle asset, such as a bus, or a separate category of game asset all together (e.g., a building), have not been modified to be black. Validation metric(s) 332 may output, for viewing on client device 202, an indication of successful reintegration or an indication of an error. In the case of an error, the video game developer may perform additional modifications to resolve the error, or in some examples, the LMM 312 may automatically fix the error without human interaction.

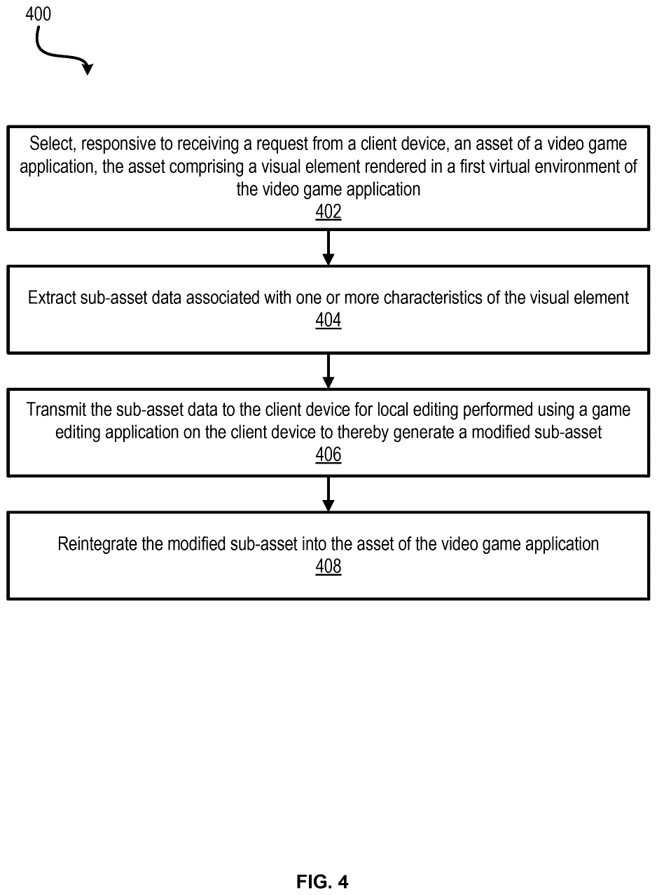

FIG. 4 illustrates an example of a process for AI-assisted asset separation, editing, and reintegration, according to an embodiment of the present disclosure. The operations of process 400 will be described with respect to computing environment 200 for cloud game development shown in FIG. 2 and FIG. 3; however, any suitable system or platform according to this disclosure may be employed. Additionally, the operations of process 400 can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations can be omitted, skipped, and/or reordered.

At block 402, cloud server system 204 selects, responsive to receiving a request 301 from a client device 202, an asset 214 of a video game application 212. The asset 214 can comprise a visual element rendered in a first virtual environment of the video game application 212. The first virtual environment may be rendered by a gaming engine 210 hosting the video game application 212 and the first virtual environment can include a plurality of assets including, but not limited to, artwork assets such as paintings, sculptures, etc., furniture assets, such as cabinets, couches, lighting, etc., building assets, such as flooring, windows, walls, etc., gaming assets, such as a weaponry, maps, player character accessories, and so on. The request may comprise text data semantically describing the asset of interest. To reduce latency and improve computer efficiencies during development of video game application 212, the cloud server system 204 may download a portion of video game application 212 including the assets specified in the request. In some examples, the request may specify the kind of development that will be performed on client device 202.

In some examples, selecting the asset 214 of the video game application 212 is performed using machine learning module 250, which may include comprising a pair of neural networks stored in a feature representation module 304. A first neural network 302 is configured for text understanding and a second neural network 306 is configured for image understanding. In more detail, selecting the asset can comprise capturing, using a virtual camera 260, a plurality of 2D images 262 of the first virtual environment and transforming, using the second neural network 306, each image of the plurality of 2D images into a respective feature vector, where each respective feature vector corresponds to visual content of each image. Additionally, the first neural network 302 may transform text data extracted from the request 301 into a feature vector representing a semantic content of the request 301. Moreover, the machine learning module 250 can include LMM 312 that can compare the feature vector representing the semantic content of the request 301 to each respective feature vector corresponding to visual content of each image to determine a text-image pair(s) 320 of a shared latent space 316. Responsive to the text-image pair(s) 320 identification, the LMM 312 can extract the asset data 218 associated with the text-image pair 320 from the video game application 212.

At block 404, the cloud server system 202 can extract sub-asset data 220 associated with one or more characteristics of the visual element of the asset 214. In some examples, a first data size of the asset data 214 is greater than a second data size of the sub-asset data 220. In some examples, a third data size of the video game application 212 is greater than each of the first data size and the second data size. The sub-asset data 220 can comprise data associated with one or more characteristics of the visual element of the asset 214 and may comprise geometry characteristics, texture characteristics, materials characteristics, shading characteristics, or any combination thereof.

In some examples, the asset 214 and/or the sub-asset data 220 can comprise metadata 222. Metadata 222 can comprise data that describes asset data 218 and/or sub-asset data 220. For instance, metadata 222 can include metadata for n assets 214, including respective sub-asset data. As such asset data 218-1 may comprises metadata 222, sub-asset data 220-1 may comprise metadata 222, and so on. In one implementation, metadata 222 provides a description/indication of instances in the video game application 212 where the assets 214, including respective sub-asset data, are utilized thereby establishing a set of dependencies. Often times asset data 218 including respective sub-asset data may be reused (e.g., comprise multiple instances) across the video game application 212 during runtime. As such, metadata 222 can provide a set of dependencies linking assets 214 and sub-asset data to all instances of the video game application 212. During game editing by client device 202, in cases where a video game developer has modified an asset and/or sub-asset and wishes to propagate such edits to all instances of the asset and/or sub-asset in the video game application, cloud server system 204 may traverse all dependencies described by metadata 222 to propagate the edits appropriately, as described in more detail below.

At block 406, cloud server system 202 can transmit the sub-asset data 220 to the client device 202 for local editing performed using a game editing application 226 on the client device 202 to thereby generate a modified sub-asset. In some examples, the entirety of the asset data 218, including all sub-asset data 220-1 . . . 220-n, may be transmitted to client device 202. Transmittal of only the sub-asset data 220 (or alternatively the entire asset data 218) as described herein improve the functioning of a computer by reducing the overall size of assets and/or sub-asset data to be downloaded and transmitted to a client device 202 for local editing and modification thereby increasing transfer speeds and efficiencies and saving computer resources, such as improving and/or freeing up additional memory space. For instance, a reduction in asset and/or sub-asset data size can save memory space to enable computer resources are available for running other applications and processes more efficiently. When memory is conserved, the local client device 202 can handle multitasking operations more efficiently reducing the likelihood of slowdowns or crashes thereby optimizing overall performance.

In some examples, editing of the sub-asset data 220 (or alternatively the entire asset data 218) may be performed via LLM prompting using machine learning model(s) 228 of client device 202. For instance, and in an example where the representative asset(s) 330 is a door, the video game developer may prompt the machine learning model(s) 228 to “change the front door of the red house to have more inset panels, make it green color, with some weathering.” The machine learning model(s) 228 understands the asset based on the prompt and performs the variations to the front door geometry, textures, materials, etc. as directed by the prompt. Further, a gallery of variations of the new front door are rendered on user interface 230 via rendering engine 224 at which point the video game developer select the rendering based on preference which may then be reintegrated back into the main asset/level of the video game application 212. Additionally, or alternatively, the video game developer can provide additional prompting to machine learning model(s) 228 such as “make the green darker, the paint should be gloss, not matte, make the door handle shiny brass,” and so on. As a result, a new gallery of renderings appears and one may be selected based on preference of the video game developer.

At block 408, the cloud server system 204 can reintegrate the modified asset and/or sub-asset data 392 into the asset 214 of the video game application 212. In some examples, reintegrating the modified asset and/or sub-asset data 392 into the asset 214 of the video game application 212 is performed using the reintegration module 394 of machine learning module 250, which can be trained to connect the modified asset and/or sub-asset data 392 with data of the original asset 214. As part of the reintegration process, various post-processing checks may be performed by the cloud server system 204 to ensure proper reintegration of the modified asset and/or sub-asset data 392. In one example, the cloud server system 202 may render a second virtual environment associated with the updated video game application 334, where the second virtual environment includes one or more instances of the asset 214 having the modified asset and/or sub-asset data 392. Then, the machine learning module 250, using, for example, the LMM 312, can compare the modified asset and/or sub-asset data 392 rendered in the second virtual environment with one or more instances of the asset data and/or sub-asset data rendered in the first virtual environment to determine a variance (e.g., image-image variance 322). The machine learning module 250 can output, responsive to the image-image variance 322 satisfying a threshold, as determined by scoring analysis 390, an indication of an error (e.g., validation metric(s) 332) to the client device 202. In some examples, the comparison may be performed by comparing a first plurality of 2D images (e.g., images 262) of the first virtual environment to a second plurality of 2D images (e.g., images 380) of the second virtual environment. A similar process may also be employed by machine learning module 250 to traverse the set of dependencies of the modified asset and/or modified sub-asset to ensure all instances of the modified asset and/or modified sub-asset are rendering properly in the video game application 212. In the case of a predicted error, the cloud server system 202 may provide a message to the client device 202 and the video game developer may perform additional modifications to resolve the error. In other examples, the LMM 312 may automatically fix the error without human interaction.

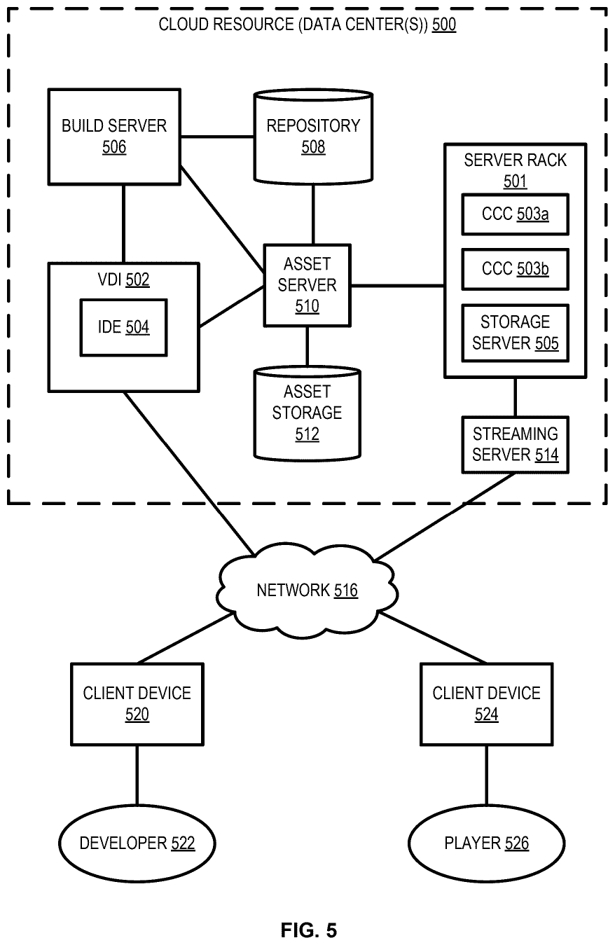

FIG. 5 illustrates another example computing environment for cloud game development using AI-assisted asset separation, editing, and reintegration, according to an embodiment of the present disclosure. In the illustrated implementation, a cloud resource 500 having cloud processing and cloud storage resources is provided. The cloud resource 500 can be an example of the cloud server system 204 described above with respect to FIGS. 2-3. In various implementations, the illustrated systems can be implemented in one or more data centers, connected over the Internet. For example, a server rack 501 can be implemented in a data center, and a given console compute card (CCC) 503a can be assigned to a player 526 and client device 524 for gameplay of a given console video game title. CCC 503a will be loaded with the video game title, and gameplay will be streamed over network 516 (including the Internet) to the player's client device 524. Server rack 501 can include storage server 505 suitable to store data accessible, for example, by one or more CCCs. In some implementations, a streaming server 514 is implemented to manage video streaming to the client device 524, for example, to optimize the video stream for network conditions, the player's hardware capabilities, etc.

In some implementations, a cloud-based game development platform is enabled by using the console compute cards in conjunction with game development systems. For example, a virtual desktop infrastructure (VDI) 502 can be implemented that allows a developer 522 operating their client device 520 to access over network 516 a virtual desktop providing cloud-hosted tools for game development, such as an integrated development environment (IDE) 504 or other development software (e.g. 3D rendering/animation software, etc.). The client device 520 may be an example of the client device 202 of FIGS. 2-3. An asset server 510 manages access to an asset storage 512 containing game assets such as textures, rigs, animations, audio, etc. A build server 506 manages access to various builds of video games, stored to a repository 508. The build server 506 can manage access to program code files, and compile program code into executables for deployment onto the console compute cards.

When a given executable build of a video game is executed by a console compute card, then the gameplay of the game build can be cloud streamed as previously described. For example, the player 526 may be a quality assurance (QA) tester or alpha/beta tester involved in supporting the development of the video game. In this manner, a cloud environment for end-to-end game development of console-based games is enabled, whereby game assets and builds are developed in the cloud, and testing on console-equivalent hardware is also cloud-based. This enables development teams and individuals, including software developers, artists, QA testers, project managers, etc. to engage and collaborate in game development activities remotely.

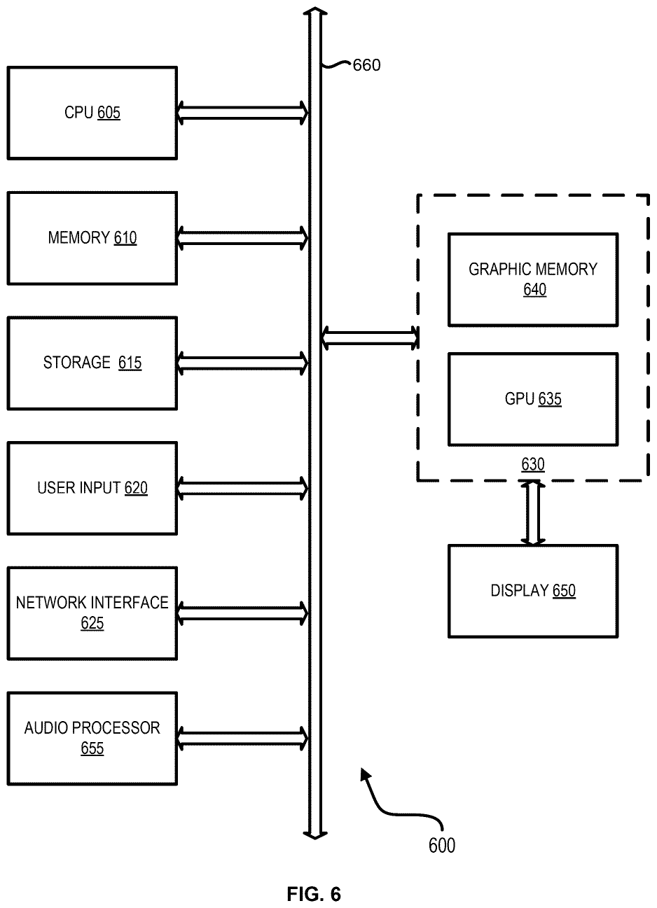

FIG. 6 illustrates an example of a computer system 600 suitable for implementing techniques of the present disclosure, according to embodiments of the present disclosure. The computer system 600 represents, for example, a video game system, a backend set of servers, or other types of a computer system. The computer system 600 includes a central processing unit (CPU) 605 for running software applications and optionally an operating system. The CPU 605 may be made up of one or more homogeneous or heterogeneous processing cores. Memory 610 stores applications and data for use by the CPU 605. Storage 615 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 620 communicate user inputs from one or more users to the computer system 600, examples of which may include keyboards, mice, thumbsticks, touch pads, touch screens, still or video cameras, and/or microphones. Network interface 625 allows the computer system 600 to communicate with other computer systems via an electronic communications network and may include wired or wireless communication over local area networks and wide area networks such as the Internet. An audio processor 655 is adapted to generate analog or digital audio output from instructions and/or data provided by the CPU 605, memory 610, and/or storage 615. The components of computer system 600, including the CPU 605, memory 610, data storage 615, user input devices 620, network interface 625, and audio processor 655 are connected via one or more data buses 660.

A graphics subsystem 630 is further connected with the data bus 660 and the components of the computer system 600. The graphics subsystem 630 includes a graphics processing unit (GPU) 635 and graphics memory 640. The graphics memory 640 includes a display memory (e.g., a frame buffer) used for storing pixel data for each pixel of an output image. The graphics memory 640 can be integrated in the same device as the GPU 635, connected as a separate device with the GPU 635, and/or implemented within the memory 610. Pixel data can be provided to the graphics memory 640 directly from the CPU 605. Alternatively, the CPU 605 provides the GPU 635 with data and/or instructions defining the desired output images, from which the GPU 635 generates the pixel data of one or more output images. The data and/or instructions defining the desired output images can be stored in the memory 610 and/or graphics memory 640. In an embodiment, the GPU 635 includes 3D rendering capabilities for generating pixel data for output images from instructions and data defining the geometry, lighting, shading, texturing, motion, and/or camera parameters for a scene. The GPU 635 can further include one or more programmable execution units capable of executing shader programs.

The graphics subsystem 630 periodically outputs pixel data for an image from the graphics memory 640 to be displayed on the display device 650. The display device 650 can be any device capable of displaying visual information in response to a signal from the computer system 600, including CRT, LCD, plasma, and OLED displays. The computer system 600 can provide the display device 650 with an analog or digital signal.

In accordance with various embodiments, the CPU 605 is one or more general-purpose microprocessors having one or more processing cores. Further embodiments can be implemented using one or more CPUs 605 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method performed by a cloud server system, the method comprising:
selecting, responsive to a request from a client device, an asset of a video game application, the asset comprising a visual element rendered in a first virtual environment of the video game application;
extracting from the asset, sub-asset data associated with one or more characteristics of the visual element;
transmitting the sub-asset data to the client device for local editing performed using a game editing application on the client device to thereby generate a modified sub-asset; and
reintegrating the modified sub-asset into the asset of the video game application.

2. The method of claim 1, wherein selecting the asset of the video game application is performed using a vision language model comprising a pair of neural networks, wherein a first neural network is configured for image understanding and wherein a second neural network is configured for text understanding.

3. The method of claim 2, further comprising:
capturing, using a virtual camera, a plurality of two-dimensional (2D) images of the first virtual environment;
transforming, using the first neural network, each image of the plurality of 2D images into a respective feature vector, each respective feature vector corresponding to visual content of each image;
transforming, using the second neural network, text data extracted from the request into a feature vector representing a semantic content of the request;
comparing, using the vision language model, the feature vector representing the semantic content of the request to each respective feature vector corresponding to visual content of each image to determine a text-image pair of a vector space shared by the first neural network and the second neural network; and
extracting, from the video game application, the asset data associated with the text-image pair.

4. The method of claim 1, wherein a first data size of the asset data is greater than a second data size of the sub-asset data, and wherein a third data size of the video game application is greater than each of the first data size and the second data size.

5. The method of claim 1, wherein the one or more characteristics of the visual element comprise geometry characteristics, texture characteristics, materials characteristics, shading characteristics, or any combination thereof.

6. The method of claim 1, wherein local editing using the game editing application on the client device is performed via large language model (LLM) prompting.

7. The method of claim 1, wherein reintegrating the modified sub-asset into the asset of the video game application is performed using a machine learning model trained to connect data associated with the modified sub-asset with data of the asset.

8. The method of claim 1, further comprising:
rendering a second virtual environment of the video game application, the second virtual environment including one or more instances of the asset having the modified sub-asset;
comparing, using a vision language model, the modified sub-asset rendered in the second virtual environment with one or more instances of the sub-asset data rendered in the first virtual environment to determine a variance; and
outputting, responsive to the variance satisfying a threshold, an indication of an error to the client device.

9. The method of claim 8, wherein comparing the modified sub-asset rendered in the second virtual environment with one or more instances of the sub-asset data rendered in the first virtual environment to determine a variance is performed by:
capturing, using a virtual camera, a first plurality of two-dimensional (2D) images of the first virtual environment;
capturing, using the virtual camera, a second plurality of 2D images of the second virtual environment, wherein each image of the second plurality of 2D images is mapped to an image of the first plurality of 2D images having a same viewing angle;
determining, based on a comparison between feature representations of mapped images, a difference in visual content between a first image mapped to a second image; and
outputting, responsive to the variance satisfying a threshold, an indication of an error to the client device.

10. The method of claim 1, wherein the asset is one of a plurality of assets of the video game application, wherein the sub-asset data comprises metadata indicating all instances in the video game application where an asset of the plurality of assets utilizes the sub-asset data thereby establishing a plurality of dependencies.

11. The method of claim 10, further comprising:
rendering a second virtual environment of the video game application including the modified sub-asset;
traversing, using a vision language model implemented by the cloud server system, the plurality of dependencies in the video game application to predict one or more errors in reintegration of the modified sub-asset to one or more assets of the plurality of assets; and
outputting, an indication of a predicted error to the client device.

12. A cloud server system comprising:
one or more processors; and
one or more memories storing executable instructions that, upon execution by the one or more processors, cause the cloud server system to perform operations to:
select, responsive to a request from a client device, an asset of a video game application, the asset comprising a visual element rendered in a first virtual environment of the video game application
extract from the asset, sub-asset data associated with one or more characteristics of the visual element;
transmit the sub-asset data to the client device for local editing performed using a game editing application on the client device to thereby generate a modified sub-asset; and
reintegrate the modified sub-asset into the asset of the video game application.

13. The cloud server system of claim 12, wherein selecting the asset of the video game application is performed using a vision language model comprising a pair of neural networks, wherein a first neural network is configured for image understanding and wherein a second neural network is configured for text understanding.

14. The cloud server system of claim 13, wherein the instructions further cause the cloud server system to perform operations to:
capture, using a virtual camera, a plurality of two-dimensional (2D) images of the first virtual environment;
transform, using the first neural network, each image of the plurality of 2D images into a respective feature vector, each respective feature vector corresponding to visual content of each image;
transform, using the second neural network, text data extracted from the request into a feature vector representing a semantic content of the request;
compare, using the vision language model, the feature vector representing the semantic content of the request to each respective feature vector corresponding to visual content of each image to determine a text-image pair of a vector space shared by the first neural network and the second neural network; and
extract, from the video game application, the asset data associated with the text-image pair.

15. The cloud server system of claim 12, wherein the one or more characteristics of the visual element comprise geometry characteristics, texture characteristics, materials characteristics, shading characteristics, or any combination thereof, wherein local editing using the game editing application on the client device is performed via large language model (LLM) prompting, and wherein reintegrating the modified sub-asset into the asset of the video game application is performed using a machine learning model trained to connect data associated with the modified sub-asset with data of the asset.

16. The cloud server system of claim 12, wherein the instructions further cause the cloud server system to perform operations to:
render a second virtual environment of the video game application, the second virtual environment including one or more instances of the asset having the modified sub-asset;
compare, using a vision language model, the modified sub-asset rendered in the second virtual environment with one or more instances of the sub-asset data rendered in the first virtual environment to determine a variance; and
output, responsive to the variance satisfying a threshold, an indication of an error to the client device.

17. The cloud server system of claim 16, wherein the operations for comparing the modified sub-asset rendered in the second virtual environment with one or more instances of the sub-asset data rendered in the first virtual environment to determine a variance comprise:
capturing, using a virtual camera, a first plurality of two-dimensional (2D) images of the first virtual environment;
capturing, using the virtual camera, a second plurality of 2D images of the second virtual environment, wherein each image of the second plurality of 2D images is mapped to an image of the first plurality of 2D images having a same viewing angle;
determining, based on a comparison between feature representations of mapped images, a difference in visual content between a first image mapped to a second image; and
outputting, responsive to the variance satisfying a threshold, an indication of an error to the client device.

18. The cloud server system of claim 12, wherein the asset is one of a plurality of assets of the video game application, wherein the sub-asset data comprises metadata indicating all instances in the video game application where an asset of the plurality of assets utilizes the sub-asset data thereby establishing a plurality of dependencies.

19. The cloud server system of claim 18, wherein the instructions further cause the cloud server system to perform operations to:
render a second virtual environment of the video game application including the modified sub-asset;
traverse, using a vision language model implemented by the cloud server system, the plurality of dependencies in the video game application to predict one or more errors in reintegration of the modified sub-asset to one or more assets of the plurality of assets; and
output, an indication of a predicted error to the client device.

20. A computer-readable storage medium storing computer-executable instructions that, when executed by one or more processors, cause operations comprising:
selecting, responsive to a request from a client device, an asset of a video game application, the asset comprising a visual element rendered in a first virtual environment of the video game application;
extracting from the asset, sub-asset data associated with one or more characteristics of the visual element;
transmitting the sub-asset data to the client device for local editing performed using a game editing application on the client device to thereby generate a modified sub-asset; and
reintegrating the modified sub-asset into the asset of the video game application.
